(19) United States
(12) Patent Application Publication
(10) Pub. No.: US 2006/0039489 A1
(43) Pub. Date: Feb. 23, 2006

(54) Method and apparatus for providing closed-loop transmit precoding

(75) Inventors: Muhammad Z. Ikram, Richardson, TX (US); Eko N. Onggosanusi, Allen, TX (US); Vasanthan Raghavan, Madison, WI (US); Anand G. Dabak, Plano, TX (US); Srinath Hosur, Plano, TX (US); Badrinarayanan Varadarajan, Dallas, TX (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 11/182,083

(22) Filed: Jul. 15, 2005

Related U.S. Application Data
(60) Provisional application No. 60/602,502, filed on Aug. 17, 2004.
(60) Provisional application No. 60/614,624, filed on Sep. 30, 2004.

(51) Int. Cl. H04K 1/10; H04L 27/04; H04L 1/02

(52) U.S. Cl. 375/260; 375/299; 375/347

(57) ABSTRACT

A method for providing closed-loop transmit precoding between a transmitter and a receiver, includes defining a codebook that includes a set of unitary rotation matrices. The receiver determines which preceding rotation matrix from the codebook should be used for each sub-carrier that has been received. The receiver sends an index to the transmitter, where the transmitter reconstructs the precoding rotation matrix using the index, and precodes the symbols to be transmitted using the preceding rotation matrix. An apparatus that employs this closed-loop technique is also described.

### CROSS-REFERENCE TO RELATED APPLICATIONS

This application claims priority to U.S. Provisional Application No. 60/602,502 filed Aug. 17, 2004, and entitled “Enhanced Closed-Loop MIMO Design for OFDM/OFDMA-PHY,” by Muhammad lkram et al, and U.S. Provisional Application No. 60/614,624 filed Sep. 30, 2004, and entitled “Enhanced Closed-Loop MIMO Design for OFDM/OFDMA-PHY,” by Muhammad Ikram et al, both of which are incorporated herein by reference.

### FIELD OF THE INVENTION

This invention relates in general to the field of wireless communications, and more specifically, to a method and apparatus for providing closed loop transmit preceding.

### BACKGROUND OF THE INVENTION

Multiple Input, Multiple Output (MIMO) refers to the use of multiple transmitters and receivers (multiple antennas) on wireless devices for improved performance. When two transmitters and two or more receivers are used, two simultaneous data streams can be sent, thus doubling the data rate. Various wireless standards that are based on MIMO orthogonal frequency-division multiplexing (OFDM) technology use the open loop mode of operation. In the open-loop MIMO mode of operation, the transmitter assumes no knowledge of the communication channel. Although the open-loop MIMO mode may be simple to implement, it suffers performance issues. An alternative to open-loop mode is closed-loop processing, whereby channel-state information is referred from the receiver to the transmitter to precode the transmitted data for better reception. Closed-loop operation offers improved performance over open-loop operation, though not free of cost. The transmission of channel-state information from the receiver to the transmitter involves significant overhead. Furthermore, the overhead cost of providing the necessary feedback is even higher in Orthogonal Frequency Division Multiplexing (OFDM)/Orthogonal Frequency Division Multiple Access (OFDMA) systems, where a different eigenvector is associated with each sub-carrier. It is desirable, therefore, to design a reduced-feedback closed-loop mode of operation with the performance similar to that obtained using the full channel-state information feedback.

### SUMMARY

The problems noted above are solved in large part by a method and system to provide closed-loop transmit precoding between a transmitter and a receiver. A codebook is defined that includes a set of precoding rotation matrices. In the system and method of the present disclosure, the receiver determines which precoding rotation matrix from the codebook should be used for each sub-carrier received. The receiver sends an index to the transmitter, where the transmitter reconstructs the selected precoding rotation matrix using the index, and precodes the symbols to be transmitted using the precoding rotation matrix.

Some illustrative embodiments may include a method for providing closed-loop transmit precoding between a transmitter and a receiver, including the steps of defining a codebook that includes a set of precoding rotation matrices, and determining at the receiver a precoding rotation matrix from the codebook for each transmission sub-carrier that is received. Having determined a precoding rotation matrix for each transmission sub-carrier, the method comprises sending an index to the transmitter for each sub-carrier received, reconstructing the precoding rotation matrix selected by the receiver for each sub-carrier at the transmitter using the indices sent to the transmitter, and precoding information to be transmitted by the transmitter to the receiver using the reconstructed precoding rotation matrices.

Other illustrative embodiments may include a communication system including a receiver including a codebook that includes one or more precoding rotation matrices, and a transmitter transmitting information to the receiver using a sub-carrier, wherein the receiver determines a precoding rotation matrix from the codebook for the sub-carrier and sends an index to the transmitter indicating the precoding rotation matrix the transmitter should use for the sub-carrier.

Yet further illustrative embodiments may include a receiver including a plurality of antennas, a memory adapted to store a codebook comprising one or more precoding rotation matrices, and selection logic for choosing a precoding rotation matrix from among the one or more precoding rotation matrices based on information that has been received.

Other illustrative embodiments may include a receiver including means for storing one or more precoding rotation matrices, and means for selecting a precoding rotation matrix from among the one or more precoding rotation matrices based on information that has been received.

Still further illustrative embodiments may include a transmitter comprising a plurality of antennas, a memory adapted to store a codebook comprising one or more precoding rotation matrices, and an indexing logic adapted to select which preceding rotation matrix should be used based on an index received by the antenna.

### BRIEF DESCRIPTION OF THE DRAWINGS

FIG. 1 is a block diagram of a communication system in accordance with an embodiment of the invention.

FIG. 2 is a flowchart highlighting a closed-loop MIMO method in accordance with an embodiment of the invention.

FIG. 3 is a graph highlighting simulation results for a 2×2 open-loop MIMO versus a closed-loop MIMIO using QPSK, rate ¾, ρ=0.7 in accordance with an embodiment of the invention.

FIG. 4 is a graph highlighting simulation results for a 2×2 open-loop MIMO versus a closed-loop MIMO using 16-QAM, rate ¾, ρ=0.7 in accordance with an embodiment of the invention.

FIG. 5 is a graph highlighting simulation results for a 2×2 open-loop MIMO versus a closed-loop MIMO using 64-QAM, rate ¾, ρ=0.7 in accordance with an embodiment of the invention.

FIG. 6 is a graph highlighting simulation results for a 2×2 open-loop MIMO versus a closed-loop MIMO using QPSK, rate ¾, ρ=0.2 in accordance with an embodiment of the invention.

FIG. 7 is a graph highlighting simulation results for a 2×2 open-loop MIMO versus a closed-loop MIMO using 16-QAM, rate ¾, ρ=0.2 in accordance with an embodiment of the invention.

FIG. 8 is a graph highlighting simulation results for a 2×2 open-loop MIMO versus a closed-loop MIMO using 16-QAM, rate ½, ρ=0.2 in accordance with an embodiment of the invention.

FIG. 9 is a graph highlighting simulation results for a 4×4 open-loop MIMO versus a closed-loop MIMO using QPSK, rate ¾, ρ=0.7 in accordance with an embodiment of the invention.

FIG. 10 is a graph highlighting simulation results for a 4×4 open-loop MIMO versus a closed-loop MIMO using 16-QAM, rate ¾, ρ=0.2 in accordance with an embodiment of the invention.

FIG. 11 is a graph highlighting simulation results for a 2×2 open-loop MIMO versus a 4×2 closed-loop MIMO using QPSK, rate ¾, ρ=0.7 in accordance with an embodiment of the invention.

FIG. 12 is a graph highlighting simulation results for a 2×2 open-loop MIMO versus a 4×2 closed-loop MIMO using 16-QAM, rate ¾, ρ=0.7 in accordance with an embodiment of the invention.

FIG. 13 is a graph highlighting simulation results for a 2×2 open-loop MIMO versus a 4×2 closed-loop MIMO using 64-QAM, rate ¾, ρ=0.2 in accordance with an embodiment of the invention.

FIG. 14 is a table highlighting the closed-loop performance for various MIMO modes in accordance with an embodiment of the invention.

FIG. 15 shows a diagram of a communication system in accordance with an embodiment of the invention.

### DETAILED DESCRIPTION OF THE PREFERRED EMBODIMENTS

In one embodiment of the invention, a closed-loop MIMO transmission methodology, where the transmitted symbols are precoded using a finite set of pre-defined unitary rotation matrices, is described. This set of matrices belong to a codebook which is known both to the receiver and to the transmitter. Given the received data, the receiver determines the optimum rotation matrix for each OFDM/OFDMA sub-carrier that will result in the best performance. The receiver transmits the index or indexes of the optimum rotation matrix(s) to the transmitter, where the matrix(s) is reconstructed and used to precode the transmitted symbols. With a very few number of rotation matrices in the basic codebook, the amount of feedback involved is less than if the full set of channel coefficients are sent back from the receiver to the transmitter.

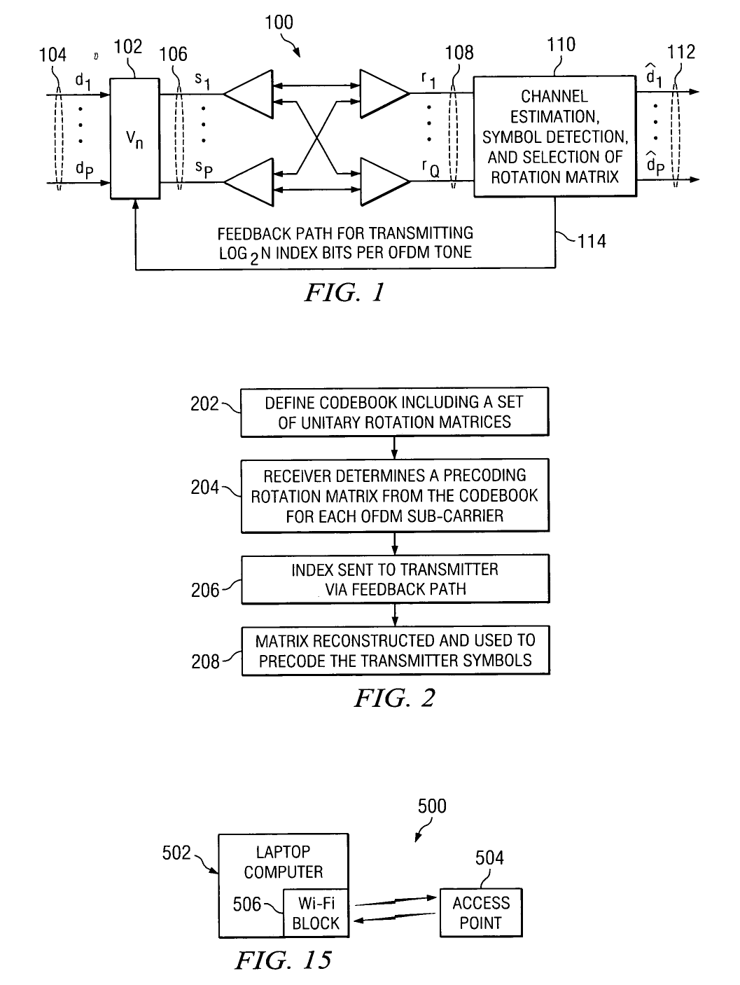

Consider a MIMO OFDM setup with P transmit antennas and Q receive antennas as shown in FIG. 1. In FIG. 1 there is shown a communication system 100 including a receiver, having Q antennas, and a transmitter, having P antennas, the Q-dimensional baseband received signal vector r=[r₁,r₂, . . . ,r_{Q}]^{T} 108 is represented as

$$r = {\sum }_{p = 1}^{P} {h}_{p} {s}_{p} + w = Hs + w ,$$

where hᵢ=[h₁ᵢ,h₂ᵢ, . . . ,h_{Qi}]^{T} is a Q-dimensional vector containing channel coefficients from i-th transmitter to Q receivers, H=[h₁,h₂, . . . , h_{P}] is the Q×P channel matrix, s=[s₁,s₂, . . . ,s_{P}]^{T} 106 is the P-dimensional transmit signal vector, and w=[w₁,w₂, . . . , w_{Q}]^{T} is the Q-dimensional vector of zero-mean noise with variance σ². The received signal can be processed by using either an optimal maximum-likelihood method or a sub-optimal method, such as zero-forcing or linear minimum mean squared error processing.
The vectors is represented by
s=Vd,
where d=[d₁,d₂, . . . ,d_{R}]^{T} 104 is the R-dimensional vector of symbols to be transmitted, V is the P×R precoding rotation matrix 102, and R is the number of transmit data streams. The reason for introducing this notation is the added flexibility of treating closed-loop and open-loop options within the same framework. This notation also allows consideration of cases having transmit data streams less than or equal to the number of transmit antennas. For the open loop case, V is simply a P×P identity matrix. The effective (rotated) channel matrix is, therefore, denoted by
H^{r}=HV.

If perfect channel state information is available at the transmitter, then the transmitted symbols can be precoded with the eigenvectors V of the matrix H^{H}H, where (·)_{H} denotes conjugate transposition. In this case, the transmitted symbols can be separated at the receiver, thereby achieving capacity. The transmission of complete channel state information from receiver to the transmitter, however, is prohibitively expensive in terms of overhead.

In accordance with an embodiment of the invention, an alternative to sending the complete channel state information is to define a codebook containing a finite set of N unitary rotation matrices. The codebook is known to both the transmitter and the receiver. Based on a metric that maximizes post-processed signal-to-noise ratio (SNR), the receiver determines a precoding rotation matrix from the codebook for each OFDM sub-carrier. An index of this matrix is then sent to the transmitter via a feedback path (shown as 114 in FIG. 1), where the same matrix is reconstructed and used to precode the transmitted symbols.

As shown in the communication system that includes a receiver and transmitter in FIG. 1, this operation requires only log₂ N bits to be fed back along the feedback path 114 per OFDM sub-carrier (tone) by block 110. Block 110 also performs the channel estimation, symbol detection and the selection of the rotation matrix. For example, if the set has eight rotation matrices, then three bits per sub-carrier are sent back. Block 110 may comprise selection logic for choosing a preceding rotation matrix from among the one or more precoding rotation matrices based on information that has been received, as well as logic adapted to other purposes, such as channel estimation and symbol detection.

As an example, the 2×2 (two transmit/two receive antenna) scenario is reviewed first herein, followed by the generalized P×Q case, where P=Q>2. The discussion herein will also show that 2×2 is a special case of the generalized P×Q MIMO case, allowing treatment of all the MIMO cases using a single unified framework. The design of a 4×2 MIMO system with 2 transmit streams and 4 transmit antennas will also be discussed. For all the schemes, the design of the codebook and the impact of its size on the performance gain of closed-loop schemes in accordance with different embodiments of the invention will also be discussed.

2×2 MIMO

For 2×2 MIMO, the codebook is defined with a set of N rotation matrices denoted by V as follows:

$${V}_{{N}_{1} {n}_{2} + {n}_{1}} = [ \begin{matrix}{ⅇ}^{j {ϕ}_{{n}_{2}}} cos {θ}_{{n}_{1}} & - {ⅇ}^{j {ϕ}_{{n}_{2}}} sin {θ}_{{n}_{1}} \\ sin {θ}_{{n}_{1}} & cos {θ}_{{n}_{1}}\end{matrix} ] , where , \\ {ϕ}_{{n}_{2}} = \frac{2 π {n}_{2}}{{N}_{2}} , {n}_{2} = 0 , 1 , … , {N}_{2} - 1$$

$${θ}_{{n}_{1}} = \frac{π {n}_{1}}{2 {N}_{1}} , {n}_{1} = 0 , 1 , … , {N}_{1} - 1$$

and N=N₁N₂.
Note that for each sub-carrier, the index of the rotation matrix may be sent from the receiver to the transmitter only once per frame. This is assuming that the channel stays static over the frame duration.
P×Q (P=Q) MIMO

Considering the general P×Q case, where P=Q>2. The real unitary rotation is generated by applying a sequence of P(P−1)/2 Givens rotation to the channel matrix as follows:

$$V ( θ ) = {\prod }_{i = 1}^{P - 1} {\prod }_{k = i + 1}^{P} G ( i , k , θ ) ,$$

where the Givens rotation matrix is given as:

$$G ( i , k , θ ) = \begin{matrix}[ \begin{matrix}1 & ⋯ & 0 & ⋯ & 0 & ⋯ & 0 \\ ⋮ & ⋰ & ⋮ & & ⋮ & & ⋮ \\ 0 & ⋯ & c & ⋯ & s & ⋯ & 0 \\ ⋮ & & ⋮ & ⋰ & ⋮ & & ⋮ \\ 0 & ⋯ & - s & ⋯ & c & ⋯ & 0 \\ ⋮ & & ⋮ & & ⋮ & ⋰ & ⋮ \\ 0 & ⋯ & 0 & ⋯ & 0 & ⋯ & 1\end{matrix} ] & \begin{matrix}\begin{matrix}Row i \\ \end{matrix} \\ Row k\end{matrix} \\ \begin{matrix}Col . i & Col . k\end{matrix} & \end{matrix}$$

with c=cos(θ) and s=sin(θ). Since G(i,k,θ) is orthogonal, the resulting rotation matrix V(θ) is unitary.

Note that each Givens rotation in the above product can be associated with a different rotation angle. For example, for P=Q=3, V(θ₁,θ₂,θ₃) is the product of three Givens rotations as follows:
V(θ₁,θ₂,θ₃)=G(1,2,θ₁)G(1,3,θ₂)G(2,3,θ₃).
As in the 2×2 case, the Givens rotation angles are quantized to form a codebook of unitary matrices. For instance, for a 3×3 scenario, the quantized set of N rotation matrices is given by

$${V}_{{N}_{1} {N}_{2} {n}_{2} + {N}_{1} {n}_{3} + {n}_{1}} = G ( 1 , 2 , {θ}_{{n}_{1}} ) G ( 1 , 3 , {θ}_{{n}_{2}} ) G ( 2 , 3 , {θ}_{{n}_{3}} ) , where$$

$${θ}_{{n}_{1}} = \frac{π {n}_{1}}{2 {N}_{1}} , {n}_{1} = 0 , 1 , … , {N}_{1} - 1 , \\ {θ}_{{n}_{2}} = \frac{π {n}_{2}}{2 {N}_{2}} , {n}_{2} = 0 , 1 , … , {N}_{2} - 1 , \\ {θ}_{n3} = \frac{π {n}_{3}}{2 {N}_{3}} , {n}_{3} = 0 , 1 , … , {N}_{3} - 1 , \\ and N = {N}_{1} {N}_{2} {N}_{3} .$$

The feedback bits for this case equals log₂N bits. If each rotation is quantized to four angles, then (N₁,N₂,N₃)=(4,4,4), resulting in a total of N=64 unitary rotation matrices. This implies a feedback of 6 bits per OFDM sub-carrier. The selection of optimum rotation matrix is similar to the 2×2 case and will be discussed further below.

From the above discussion, it can be appreciated that the Givens rotation approach to the generation of P×Q unitary matrices can be extended to higher MIMO configurations. For example, for a 4×4 system, the matrix V is a product of P(P−1)/2=6 Givens rotations. Moreover, note that the 2×2 system is a special case of Givens rotation, where only one rotation is employed.

4×2 MIMO

For 4 transmit antennas with 2 transmit streams, the transmitter is split into two 2-transmit antenna units. Each unit then transmits one data stream. A 2×1 preceding vector is associated with each data stream. The two resulting vectors are combined to form the preceding matrix V as follows:

$${V}_{{N}_{1} {n}_{2} + {n}_{1}} = [ \begin{matrix}{w}_{{n}_{1}} & 0 \\ 0 & {w}_{{n}_{2}}\end{matrix} ] , where$$

$${w}_{{n}_{1}} = [ \begin{matrix}1 \\ {ⅇ}^{j ( π / 4 + 2 π {n}_{1} / {N}_{1} )}\end{matrix} ] , {n}_{1} = 0 , … , {N}_{1} - 1 , \\ {w}_{{n}_{2}} = [ \begin{matrix}1 \\ {ⅇ}^{j ( π / 4 + 2 π {n}_{2} / {N}_{2} )}\end{matrix} ] , {n}_{2} = 0 , … , {N}_{2} - 1 , and N = {N}_{1} {N}_{2} .$$

Selection of Rotation Matrix

The selection of the rotation matrix depends on the type of receiver employed to recover the transmitted source symbols. In one embodiment of the invention, an iterative minimum-mean squared error (IMMSE) receiver is used, which detects the transmitted symbols in the order of decreasing post-processed SNR; i.e., the most “reliable” symbols are detected first and removed from the received signal followed by estimating symbols of decreasing reliability. The present invention can be used with other types of receivers. The MMSE post-processed SNR of the P received symbol streams is given by:

$${SNR}_{i} = {{h}_{i}^{H} ( {\sum }_{{j = 1}_{j \neq i}}^{P} {h}_{j} {h}_{j}^{H} + {σ}^{2} I )}^{- 1} {h}_{i} , i = 1 , … , P ,$$

where hᵢ is the i-th column of the channel matrix H and I is the P×P identity matrix. The above SNR value is computed for the open-loop transmission.

In order to pick the best rotation matrix for each tone in the OFDM symbol, the post-processed SNR for each unitary rotation matrix in the basis set is computed. Defining the rotated channel matrix as:
Hₙ^{r}=HVₙ, n=0,1, . . . ,N−1,
then the post-processed SNR for each case is given by:

$${SNR}_{n , i}^{r} = {{h}_{n , i}^{rH} ( {\sum }_{{j = 1}_{j \neq i}}^{P} {h}_{n , j}^{r} {h}_{n , j}^{rH} + {σ}^{2} I )}^{- 1} {h}_{n , i}^{r} , i = 1 , … , P ; n = 0 , … , N - 1.$$

Of the P received streams, the smallest SNR value is selected and maximized over all possibilities of the rotation matrices. Mathematically, the selection of rotation matrix can be stated as:

$${V}_{n}^{opt} = arg {max}_{n} ( {min}_{i} ( {SNR}_{n , i}^{r} ) ) .$$

The above operation guarantees the maximization of the minimum post-processed SNR over all the possible choices. Note that for IMMSE processing, the interference term

$${\sum }_{{j = 1}_{j \neq i}}^{P} {h}_{n , j}^{r} {h}_{n , j}^{rH}$$

deflates each time a signal is estimated and subtracted from the received signal.

Referring now to FIG. 2, there is shown a flowchart highlighting a method for providing closed-loop transmit preceding in accordance with an embodiment of the invention. In 202, a codebook is defined which includes a set of unitary rotation matrices as previously discussed. The codebook may be known to both the receiver and the transmitter. In 204, a receiver determines a precoding rotation matrix from the codebook for each OFDM sub-carrier. In 206, an index for each sub-carrier is sent by the receiver to the transmitter via a feedback path. While in 208, the rotation matrix is reconstructed from the index sent, and the reconstructed rotation matrix is used to precode the symbols that will be transmitted.

In FIG. 15, there is shown an illustrative example of a communication system 500 employing the closed-loop scheme of the present invention. A communication device such as a laptop computer 502 that includes wireless interconnection capability in the form of a Wi-Fi circuit 506 communicates with an access point (also known as hot spot, etc.) 504. Although shown using a Wi-Fi communication block (e.g., wireless communication card) other communication standards can also be used in association with the closed-loop technique of the present invention. In one embodiment, the codebooks are stored in both the laptop computer 502 and the access point 504 or in another illustrative example in the access point controller which may be located remotely from the access point 504.

Simulation Results

To verify the potential of the proposed closed-loop method in accordance with an embodiment of the invention, numerical simulations for various baseband MIMO OFDM system configurations employing an IMMSE receiver were performed. For the simulations, 768 data tones in the OFDM symbol were considered, which employed 1024-point inverse fast Fourier transform/fast Fourier transform (IFFT/FFT) at the transmitter/receiver. The frame duration was set to 5 msec and a delay of 2 frames was used for the feedback of channel-state information. Convolutional coding was used for forward-error correction and employed an iterative minimum mean squared error (IMMSE) receiver for decoding of transmitted symbols.

In the simulations, the International Telecommunication Union (ITU) outdoor-to-indoor pedestrian (OIP-B) channels were used with vehicular speeds of 3 km/hr. Transmit antenna correlation of ρ=0.2 or ρ=0.7 were used in the experiments. For all the simulations performed, ideal channel knowledge was assumed at the receiver. The frame-error rate (FER) results are discussed below for each MIMO configuration, where the open-loop performance is compared against the closed-loop performance to gauge the gain.

2×2 Simulations

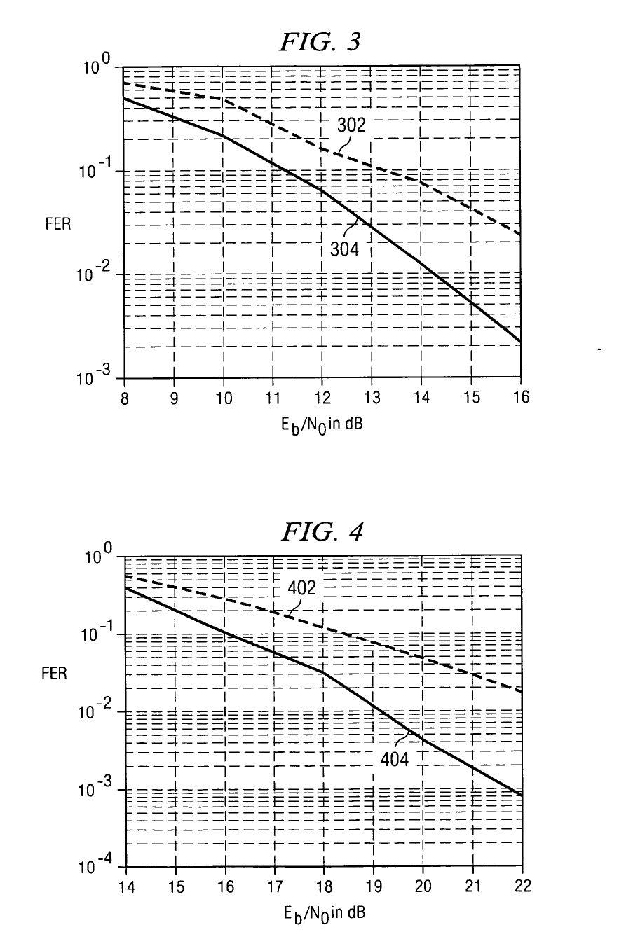

Various simulation results for 2×2 MIMO using different modulation modes are shown in FIGS. 3-8. Note that (N₁,N₂)=(4,1) corresponds to a feedback of 2 bits per sub-carrier. In FIG. 3, there is shown a performance comparison between a 2×2 open loop MIMO 302 versus a closed-loop MIMO 304 in accordance with an embodiment of the present invention. The modulation used was Quadrature Phase Shift Keying (QPSK), rate ¾ and a transmit antenna correlation, ρ=0.7. In FIG. 4 there is shown a simulation showing the performance comparison of a 2×2 open-loop MIMO 402 versus a closed-loop MIMO in accordance with an embodiment of the invention. The modulation used was 16 Quadrature Amplitude Modulation (16-QAM), rate ¾, ρ=0.7.

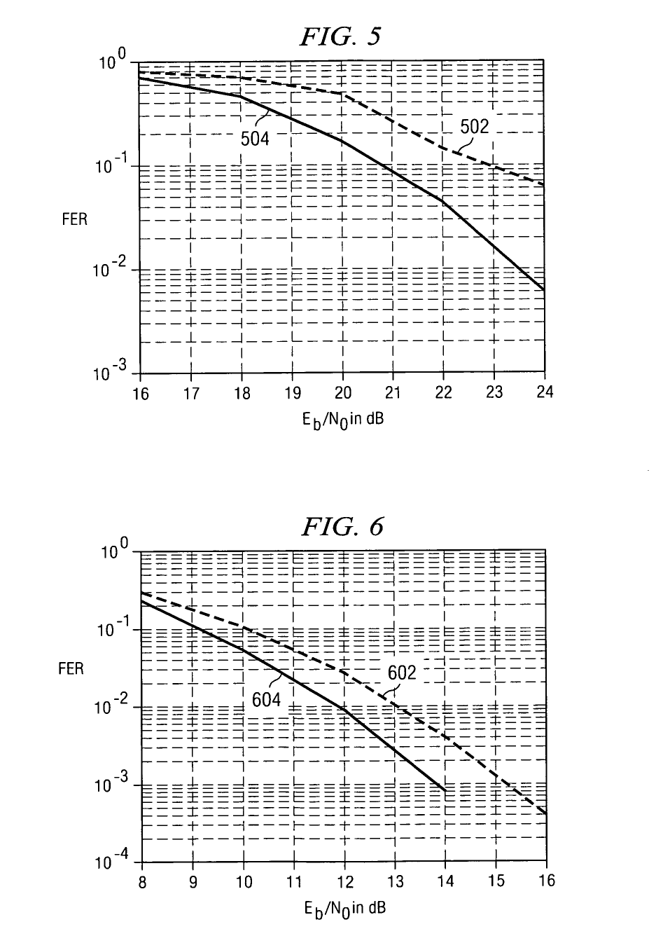

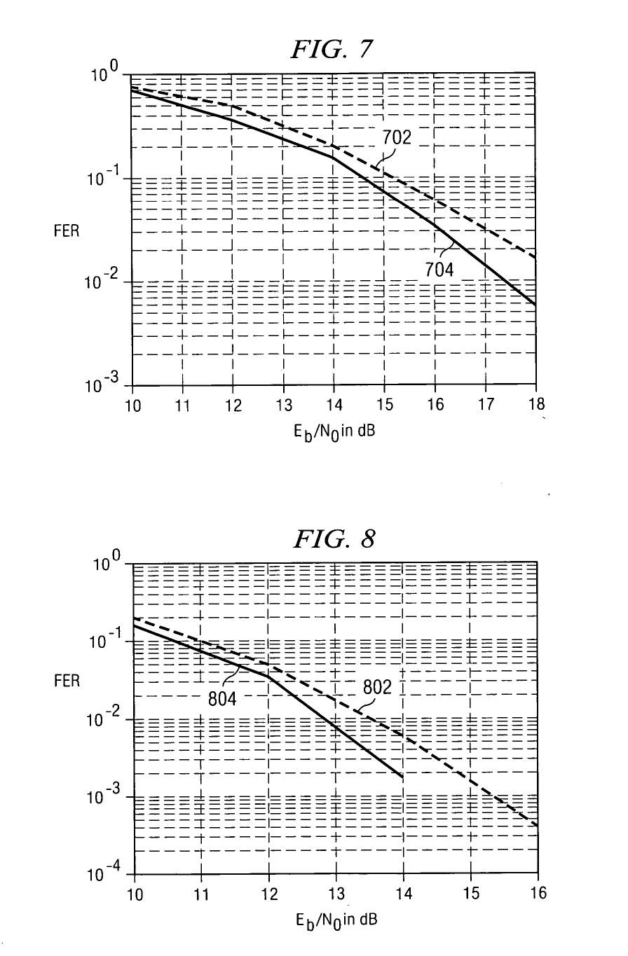

Referring now to FIG. 5, there is shown simulation results for a performance comparison between a 2×2 open-loop MIMO 502 versus a closed-loop MIMO in accordance with an embodiment of the invention. The simulation in FIG. 5 used 64-QAM, rate ¾ and ρ=0.7. In FIG. 6, there is shown another simulation highlighting the performance comparison between a 2×2 open-loop MIMO 602 against a closed-loop MIMO 604 in accordance with an embodiment of the invention. Modulation used was QPSK, rate ¾ and ρ=0.2. In FIG. 7 there is shown a simulation comparing the performance of a 2×2 open-loop MIMO 702 versus a closed-loop MIMO 704 using 16-QAM, rate of ¾ and ρ=0.2. In FIG. 8, there is another simulation result highlighting a 2×2 open-loop MIMO 802 versus a closed-loop MIMO 804 using 16-QAM, rate ½ and ρ=0.2.

4×4 Simulation Results

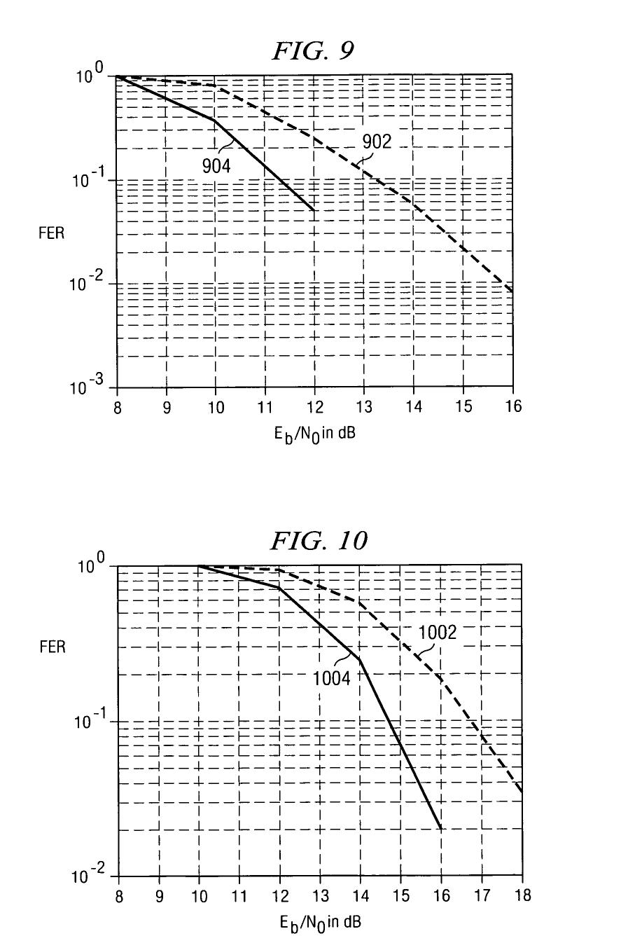

For the 4×4 simulation results depicted below, the feedback requirement is 6 bits per sub-carrier. The graph shown in FIG. 9 highlights the performance comparison of a 4×4 open-loop MIMO design 902 versus a closed-loop MIMO design 904 in accordance with an embodiment of the invention. The simulation was performed using QPSK, rate ¾ and ρ=0.7. In FIG. 10, simulation results comparing a 4×4 open-loop MIMO design 1002 versus a closed-loop MIMO 1004 in accordance with an embodiment of the invention are shown. In this simulation 16-QAM, rate ¾ and a ρ=0.2 were used.

4×2 Simulation Results

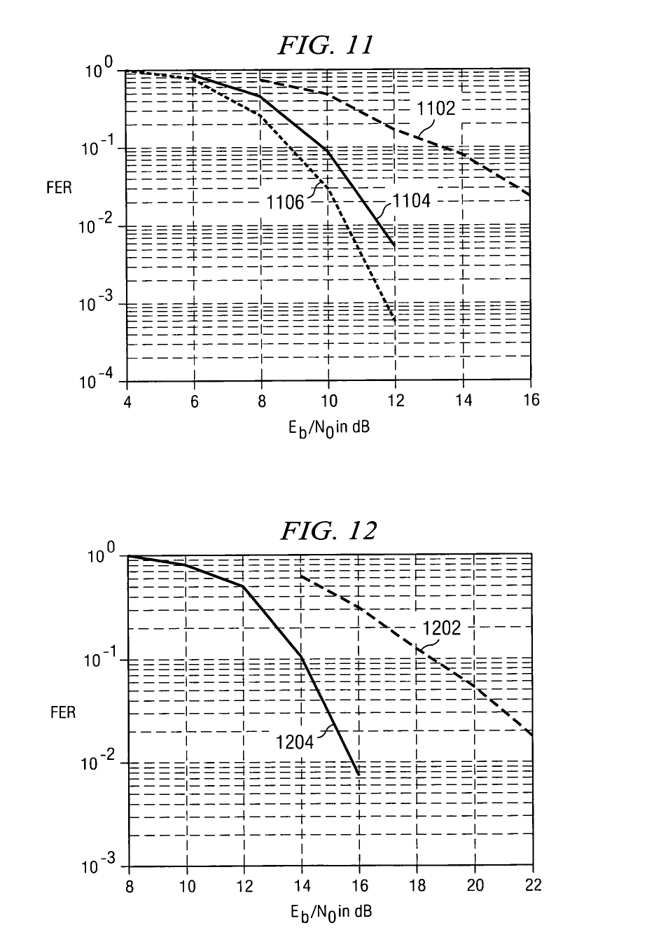

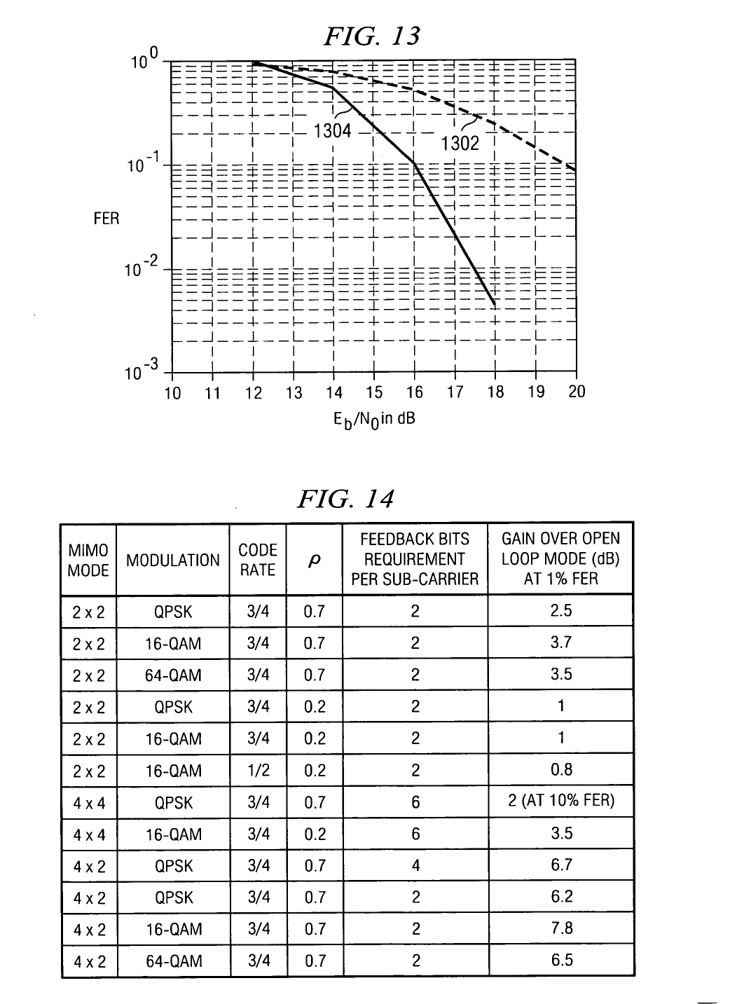

The performance of 4×2 closed-loop MIMO against the 2×2 open-loop mode are compared in FIGS. 11-13. The parameter set (N₁,N₂)=(2,2) implies a feedback of 2 bits per sub-carrier, whereas (N₁,N₂)=(4,4)corresponds to 4 bits feedback per sub-carrier. In FIG. 11, the performance of a 2×2 open-loop MIMO 1102 is compared to a 4×2 closed-loop MIMO where graph line 1104 represents a design where N₁=2 and N₂=2, and graph line 1106 is a closed-loop design were N₁=4 and N₂=4. The simulation was performed using QPSK, rate ¾ and ρ=0.7. In FIG. 12 there is shown the performance comparison of a 2×2 open-loop MIMO 1202 versus a 4×2 closed-loop MIMO represented by graph line 1204 in accordance with an embodiment of the invention. The closed-loop parameters were set to N₁=2 and N₂=2. In this simulation, QAM modulation was used with a rate ¾ and ρ=0.7. Finally, in FIG. 13, a simulation of the performance comparison of a 2×2 open-loop MIMO 1302 versus a 4×2 closed-loop MIMO 1304 using QAM modulation, rate ¾ and ρ=0.2 is shown. The closed-loop MIMO had an N₁=2 and an N₂=2. The closed-loop performance of different MIMO modes considered above is summarized in the table shown in FIG. 14. The table also lists the feedback bits required for each case.

The proposed MIMO closed-loop scheme of the present invention requires minimal feedback and results in improved gain over corresponding MIMO open-loop modes. As expected, larger gain was achieved for higher antenna correlation; also, the gain increased with the use of more transmit/receive antennas. Interpolation across frequency can be employed to further reduce the feedback requirement in the closed-loop methodology. However, interpolation works only when the OFDMA sub-carriers assigned to a user are arranged contiguously over the frequency band. Therefore, its application is limited only to certain frame structures.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

What is claimed is:

1. A method for providing closed-loop transmit precoding between a transmitter and a receiver, comprising:
defining a codebook that includes a set of precoding rotation matrices;
determining at the receiver a preceding rotation matrix from the codebook for each transmission sub-carrier that is received;
sending an index to the transmitter for each sub-carrier received;
reconstructing the precoding rotation matrix selected by the receiver for each sub-carrier at the transmitter using the indices sent to the transmitter; and
precoding information to be transmitted by the transmitter to the receiver using the reconstructed preceding rotation matrices.

2. A method as defined in claim 1, wherein the codebook is known to both the transmitter and the receiver.

3. A method as defined in claim 1, wherein the codebook is stored at both the transmitter and the receiver.

4. A method as defined in claim 1, wherein the receiver selects the precoding rotation matrix from among the set of rotation matrices for use for each sub-carrier.

5. A method as defined in claim 4, further comprising:
selecting the precoding rotation matrix from the codebook for use for each sub-carrier by determining which precoding rotation matrix maximizes post-processed signal-to-noise ratio.

6. A method as defined in claim 1, wherein sending the index comprises sending an index having a length of log2N bits, where N is the number of precoding rotation matrices found in the codebook.

7. A method as defined in claim 1, wherein the transmitter and receiver form a 2×2 MIMO system and the codebook includes a set of N precoding rotation matricies denoted by V, where:
$${V}_{{N}_{1} {n}_{2} + {n}_{1}} = [ \begin{matrix}{ⅇ}^{j {ϕ}_{{n}_{2}}} cos {θ}_{{n}_{1}} & - {ⅇ}^{j {ϕ}_{{n}_{2}}} sin {θ}_{{n}_{1}} \\ sin {θ}_{{n}_{1}} & cos {θ}_{{n}_{1}}\end{matrix} ] , \\ {ϕ}_{{n}_{2}} = \frac{2 π {n}_{2}}{{N}_{2}} , {n}_{2} = 0 , 1 , … , {N}_{2} - 1 where , \\ {θ}_{{n}_{1}} = \frac{π {n}_{1}}{2 {N}_{1}} , {n}_{1} = 0 , 1 , … , {N}_{1} - 1 and$$
$$N = {N}_{1} {N}_{2} .$$

8. A communication system comprising:
a receiver including a codebook that includes one or more precoding rotation matrices; and
a transmitter transmitting information to the receiver using a sub-carrier;
wherein the receiver determines a precoding rotation matrix from the codebook for the sub-carrier and sends an index to the transmitter indicating the preceding rotation matrix the transmitter should use for the sub-carrier.

9. The communication system as defined in claim 8, wherein the transmitter includes a copy of the codebook.

10. The communication system as defined in claim 8, wherein the receiver sends an index to the transmitter for each sub-carrier received from the transmitter.

11. The communication system as defined in claim 8, wherein the communication system comprises an Orthogonal Frequency Division Multiple Access (OFDMA) system.

12. The communication system as defined in claim 8, wherein the index has a length of log₂N bits, where N is the number of precoding rotation matrices found in the codebook.

13. The communication system as defined in claim 8, wherein the precoding rotation matrix is selected from the codebook by the receiver on a metric that maximizes signal-to-noise ratio (SNR).

14. A communication system as defined in claim 13, wherein the transmitter transmits information using the precoding rotation matrix indicated by the index the transmitter received from the receiver.

15. The communication system as defined in claim 8, further comprising a feedback path coupling the receiver and transmitter via which the receiver sends the index to the transmitter.

16. The communication system as defined in claim 8, further defined as a wireless communication device and a remote access point, coupled by a wireless interconnection capability.

17. A receiver, comprising:
a plurality of antennas;
a memory adapted to store a codebook comprising one or more precoding rotation matrices; and
selection logic for choosing a precoding rotation matrix from among the one or more precoding rotation matrices based on information that has been received.

18. The receiver as defined in claim 17, wherein the antennas are further adapted to send an index informing a transmitter the precoding rotation matrix selected by the receiver to be used.

19. The receiver as defined in claim 18, wherein the receiver sends the transmitter an index for each sub-carrier used by the transmitter.

20. The receiver as defined in claim 17, wherein the selection logic selects the preceding rotation matrix which provides the maximum signal-to-noise ratio (SNR).

21. The receiver as defined in claim 17, wherein the receiver comprises an Orthogonal Frequency Division Multiple Access (OFDMA) Multi-Input-Multi-Output (MIMO) receiver.

22. A receiver, comprising:
means for storing one or more precoding rotation matrices; and
means for selecting a preceding rotation matrix from among the one or more precoding rotation matrices based on information that has been received.

23. The receiver as defined in claim 22, further comprising:
means for sending an index which informs a transmitter the precoding rotation matrix selected by the receiver to be used.

24. The receiver as defined in claim 23, wherein the receiver sends the transmitter an index for each sub-carrier used by the transmitter.

25. The receiver as defined in claim 24, wherein the receiver comprises an Orthogonal Frequency Division Multiple Access (OFDMA) Multi-Input-Multi-Output (MIMO) receiver.

26. The receiver as defined in claim 22, wherein the means for selecting the precoding rotation matrix from among the one or more precoding rotation matrices selects the precoding rotation matrix which provides the maximum signal-to-noise ratio (SNR).

27. A transmitter, comprising:
a plurality of antennas;
a memory adapted to store a codebook comprising one or more preceding rotation matrices; and
an indexing logic adapted to select which preceding rotation matrix should be used based on an index received by the antenna.

28. The transmitter as defined in claim 27, wherein the transmitter transmits information using the selected precoding rotation matrix indicated by the index.

29. The transmitter as defined in claim 27, further comprising reconstruction logic adapted to reconstruct the selected preceding rotation matrix using the index.

30. The transmitter as defined in claim 29, further comprising preceding logic adapted to precode information to be transmitted by the transmitter using the reconstructed precoding rotation matrix.
